(19) United States
(12) Patent Application Publication
(10) Pub. No.: US 2016/0334091 A1
(43) Pub. Date: Nov. 17, 2016

(54) LED LIGHTING APPARATUS

(71) Applicant: Posco LED Company Ltd., Yongin-si (KR)

(72) Inventors: Sang Hyuk KIM, Yongin-si (KR); Seok Jin KANG, Yongin-si (KR); Yoon Gil JANG, Yongin-si (KR); Su Woon LEE, Yongin-si (KR)

(21) Appl. No.: 14/713,896

(22) Filed: May 15, 2015

(51) Int. Cl. F21V 29/61; F21V 29/67; H05B 33/08

(52) U.S. Cl. CPC F21V 29/61; H05B 33/0815; F21V 29/673; F21Y 2101/02

(57) ABSTRACT

A light emitting diode (LED) lighting apparatus includes: a power supply unit configured to convert AC current and/or voltage into DC current and/or voltage and output the converted DC current and/or voltage, a light emitting module comprising a printed circuit board (PCB) and a plurality of LEDs disposed on a first side of the PCB, wherein the light emitting module is configured to receive the DC current from the power supply unit, a fan module configured to receive the DC voltage from the power supply unit, and a temperature sensor configured to generate temperature information and transmit the temperature information to the fan module. Moreover, the temperature sensor is disposed on the PCB.

### BACKGROUND

1. Field

Exemplary embodiments relate to a light emitting diode (LED) lighting apparatus. More particularly, exemplary embodiments relate to a LED lighting apparatus emitting a plane shape light.

2. Discussion of the Background

A light emitting diode (LED) is a semiconductor element that may be made of a material, such as gallium (Ga), phosphorus (P), arsenic (As), indium (In), nitrogen (N), aluminum (Al), etc. The LED may emit any suitable color, such as red, green, blue, etc., light when a current is applied. As compared with a fluorescent lamp, the LED may have a relatively longer lifespan, a relatively faster response speed when excited (e.g., time until light is emitted after a current flows), and a relatively lower power consumption. Due, at least in part, to these advantages, the LED use is increasing. Accordingly, LEDs have found use in various kinds of lighting apparatus, such as bulbs, tubes, recessed lights, and street lamps, etc.

For example, a lighting apparatus employing an LED element (LED lighting apparatus) is increasingly being used as a factory lighting fixture in industrial workplaces, which require high light output, as well as being used in an indoor lamp in homes and offices.

However, such a LED lighting apparatus (e.g. factory lighting fixture) generates large amounts of heat during operation of a light emitting module including the LED elements.

In order to decrease heat from the light emitting module, the conventional LED lighting apparatus may include a fan which cools down the light emitting module.

However, voltage for the fan in the conventional LED lighting apparatus is typically supplied from a power supply unit, and the fan typically connects with the power supply unit using an additional connecting wire. Because of this, a structure of the LED lighting apparatus may become relatively complicated, and the weight and the size of the LED lighting apparatus also may increase.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a LED lighting apparatus including a light emitting module including a plurality of LEDs disposed on a printed circuit board (PCB) and a temperature sensor disposed on the PCB. The PCB has power patterns and power terminals according to the connecting line coupled to a fan so that the fan may be applied power through the power patterns from a power supply unit. Therefore, a structure of the LED lighting apparatus may become less complicated and the weight and the size of the LED lighting apparatus also may decrease.

Additional aspects will be set forth in the detailed description which follows, and, in part, will be apparent from the disclosure, or may be learned by practice of the inventive concept.

An exemplary embodiment discloses a light emitting diode (LED) lighting apparatus, including: a power supply unit configured to convert AC current and/or voltage into DC current and/or voltage and output the converted DC current and/or voltage, a light emitting module including a printed circuit board (PCB) and a plurality of LEDs disposed on a first side of the PCB, wherein the light emitting module is configured to receive the DC current from the power supply unit, a fan module configured to receive the DC voltage from the power supply unit, and a temperature sensor configured to generate temperature information and transmit the temperature information to the fan module, wherein the temperature sensor is disposed on the PCB.

In an embodiment, the power supply unit includes a switching mode power supply (SMPS) configured to convert AC current and/or voltage into DC current and/or voltage, and a light emitting driving controller configured to apply a substantially constant DC current to the light emitting module.

In an embodiment, the SMPS includes an AC/DC converter configured to convert an AC voltage from an external source to a DC voltage, and a DC/DC converter configured to convert the converted DC voltage to a first DC voltage.

In an embodiment, the light emitting driving controller is electrically coupled to the DC/DC converter and is configured to maintain the constant DC current applied to the light emitting module by controlling the first DC voltage.

In an embodiment, the PCB is a metal core PCB (MCPCB) or metal PCB (MPCB) based on a metal board.

In an embodiment, the PCB includes: a positive (+) input power terminal and a negative (−) input power terminal that are electrically coupled to the power supply unit, and a positive (+) output power terminal and a negative (−) output power terminal that are electrically coupled to the fan module, and wherein the positive (+) input power terminal is electrically coupled to the positive (+) output power terminal through a first power pattern formed on a second side of the PCB, and the negative (−) input power terminal is electrically coupled to the negative (−) output power terminal through a second power pattern formed on the second side of the PCB.

In an embodiment, the plurality of LEDs are connected in series, and electrically coupled to the positive (+) input power terminal and the negative (−) input power terminal.

In an embodiment, the plurality of LEDs are disposed apart from each other on the first side of the PCB and electrically coupled to each other with circuit patterns formed on a second side of the PCB.

In an embodiment, the fan module includes: a fan providing a cooling air by rotating rotor blades, and a fan driving controller configured to control a rotation speed of the fan's rotor blades according to the temperature information provided by the temperature sensor.

In an embodiment, the temperature sensor includes a thermistor and a resistor.

In an embodiment, the temperature sensor includes a first and second resistor connected in parallel, and a thermistor connected with the first resistor in parallel and connected with the second resistor in series.

In an embodiment, the thermistor is a negative temperature coefficient (NTC) thermistor whose resistance value decreases with rising temperature.

In an embodiment, the total resistance of the temperature sensor is related to the temperature information provided to a fan driving module in the fan module through a sensing line.

In an embodiment, the rotation speed of the fan is increased when the ambient air temperature is higher than a first reference temperature until the ambient air temperature reaches a second reference temperature.

In an embodiment, the temperature sensed by the temperature sensor is higher than ambient air temperature and corresponds to a rotation speed of the fan module that is lower than rotation speed of the fan module having the same temperature sensed from the ambient air.

In an embodiment, the temperature sensor is disposed on the first side of the PCB

In an embodiment, the temperature sensor is disposed on a side opposite the first side of the PCB.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram illustrating the operation of a LED lighting apparatus according to an exemplary embodiment.

FIG. 2 is a block diagram illustrating the connection of a power supply unit, a fan module, and a light emitting module shown in FIG. 1 according to a first exemplary embodiment.

FIG. 3 is a block diagram illustrating the connection of a power supply unit, a fan module, and a light emitting module shown in FIG. 1 according to a second exemplary embodiment.

FIG. 4 is a schematic plan view illustrating a PCB including LEDs, power patterns, and power terminals.

FIG. 5 is a graph illustrating electrical resistance-temperature characteristics of the thermistors.

FIG. 6 is a graph illustrating the operation of a fan driving controller.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments of the present invention will be described in detail with reference to the accompanying drawings.

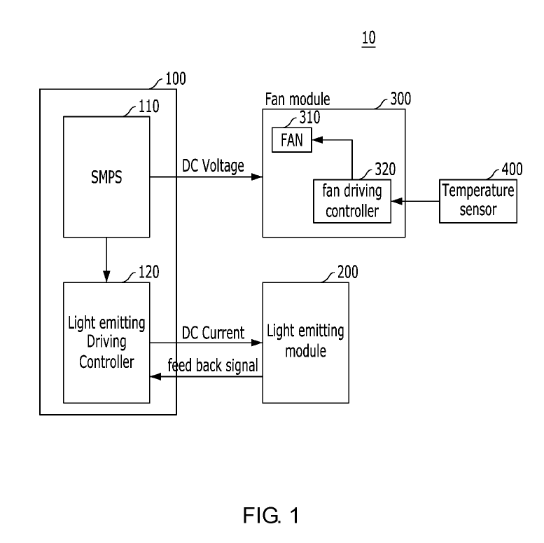

FIG. 1 is a block diagram illustrating the operation of a LED lighting apparatus according to an exemplary embodiment.

Referring to FIG. 1, the LED lighting apparatus 10 according to an exemplary embodiment includes a power supply unit 100, a light emitting module 200, a fan module 300, and a temperature sensor 400.

The power supply unit 100 provides power to the light emitting module 200 and the fan module 300. A switching mode power supply (SMPS) 110 may be included in the power supply unit 100. The SMPS 110 may serve to convert AC current (or voltage) into DC current (or voltage) and supply the DC current (or voltage) to the LEDs (not shown) in the light emitting module 200 and the fan module 300.

The LED element is a semiconductor device which emits light when a forward voltage is applied. The light output of the LED element is determined by the forward current, and the current-voltage characteristic curve of the LED element may show a very large change in the forward current based upon a small change in the forward voltage. For this reason, the power supply unit 100 is required to supply a constant current to correspond to the desired load and not change the output voltage. Therefore, the power supply unit 100 may include a LED driving circuit including a constant current source circuit in order to apply constant current to generate a uniform brightness for a plurality of LEDs in the light emitting module 200.

As shown in FIG. 1, a light emitting driving controller 120 may work as the LED driving circuit to apply a constant current to the LEDs in the light emitting module 200. The light emitting driving controller 120 may be included in the power supply unit 100 as shown FIG. 1, and the light emitting driving controller 120 may receive a feedback signal from the light emitting module 200.

That is, the power supply unit 100 may include SMPS 110 that converts an AC voltage into a DC voltage determined by the driving voltage of the light emitting module 200, and the light emitting driving controller 120 maintains a constant current applied to the LEDs in the light emitting module 200.

In this case, the SMPS 110 and the light emitting driving controller 120 may be integrally formed within one body with the power supply unit 100. Alternatively, each of the SMPS 110 and the light emitting driving controller 120 may be separate.

The light emitting module 200 may include printed circuit board (PCB) (not shown) and a plurality of LEDs (not shown) disposed on the PCB. The PCB may be a metal core PCB (MCPCB) or metal PCB (MPCB) based on a metal board having good thermal conductivity. The LEDs are disposed apart from each other on the one side of the PCB, and generate light based on driving current from the power supply unit. The LED element is capable of generating light having various wavelengths according to the use thereof, for example, red, yellow, blue, ultraviolet, etc.

The fan module 300 may include a fan 310 and a fan driving controller 320. The fan 310 may be disposed in the inner space of case body (not shown) of the LED lighting apparatus 10. The fan 310 may draw relatively cool ambient air through an air inlet (not shown) of the case body and direct the cooling air toward the heat sink (not shown) located on the light emitting module 200.

The fan 310 may include a fan case that is open at upper and lower portions, a central axis disposed in the middle of the fan case, and a plurality of rotor blades disposed in the fan case to rotate on the central axis and a driving motor.

The RPM (revolutions per minute) of the fan may be controlled according to the ambient air temperature. That is, when the ambient air temperature is higher than a reference temperature, the RPM of the fan 310 should increase in order to maintain a suitable temperature of the light emitting module. In contrast, when the ambient air temperature is lower than the reference temperature, the RPM of the fan may remain constant or decrease because the temperature of the light emitting module is not so high as to require being cooled down artificially. The fan driving controller 320 may control rotation speed of the fan according to the temperature information provided by a temperature sensor 400.

The temperature sensor 400 may be disposed on the PCB of the light emitting module 200 same as the LEDs on the PCB, and detect a change of temperature based on a change of total resistance therein.

That is, the rotation speed of the fan can be increased when the temperature sensed by the temperature sensor 400 is higher than a reference temperature.

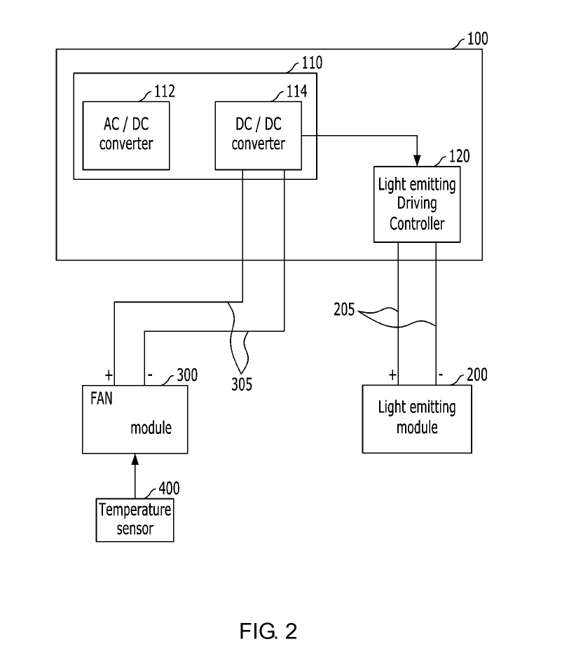

FIG. 2 is a block diagram illustrating connection of a power supply unit, a fan module, and a light emitting module shown in FIG. 1 according to a first exemplary embodiment.

Referring to FIG. 2, a power supply unit 100 may connect with a light emitting module 200 through first power lines 205 and connect with a fan module 300 through second power lines 305. That is, the light emitting module 200 and the fan module 300 may be connected separately with the power supply unit 100.

The power supply unit 100 may include a SMPS 110 and a light emitting driving controller 120 as shown in FIG. 1. Furthermore, the SMPS 110 may include an AC/DC converter 112 converting an AC voltage from an external source to a DC voltage, and a DC/DC converter 114 converting the DC voltage converted by the AC/DC converter 112 to a proper DC voltage to drive the light emitting module. The light emitting driving controller 120 coupled with the SMPS 110 may maintain the constant current applied to the light emitting module 200 by controlling the DC voltage converted by the DC/DC converter 114.

The light emitting module 200 may include a plurality of LEDs (not shown) having a various type of electrical connections thereof. That is, the LEDs may be coupled in series, in parallel, or series-parallel in accordance with an application applying the LEDs.

The fan module 300 may include a fan having a plurality of rotor blades and a driving motor, and a constant DC voltage should be applied to the fan from the power supply unit 100. Since the fan should be applied voltage from a power supply unit 100, the fan should connect with the power supply unit 100 by an additional connecting wire, that is, the second power lines 305. The fan module 300 also may include a fan driving controller controlling rotation speed of the fan according to the temperature information provided by a temperature sensor 400.

The temperature sensor may be disposed in the inner space of the case body. More specifically, the temperature sensor may be located adjacent to the outer surface of the case body to sense the ambient air temperature.

In this manner, a structure of the LED lighting apparatus according to the exemplary embodiment in FIG. 2 may become relatively complicated, and the weight and the size of the LED lighting apparatus also may increase.

Accordingly, in order to overcome such a problem, another exemplary embodiment of this invention provides a light emitting module including a printed circuit board (PCB) having power patterns and power terminals to provide the connecting wiring coupled to a fan. By doing so, a length of the connecting wire to the fan can be shorter than the second power lines in FIG. 2, and the temperature sensor may be disposed on the PCB, not taking up a separate space in the case body. Therefore, a structure of the LED lighting apparatus may become less complicated, and the weight and the size of the LED lighting apparatus also may decrease.

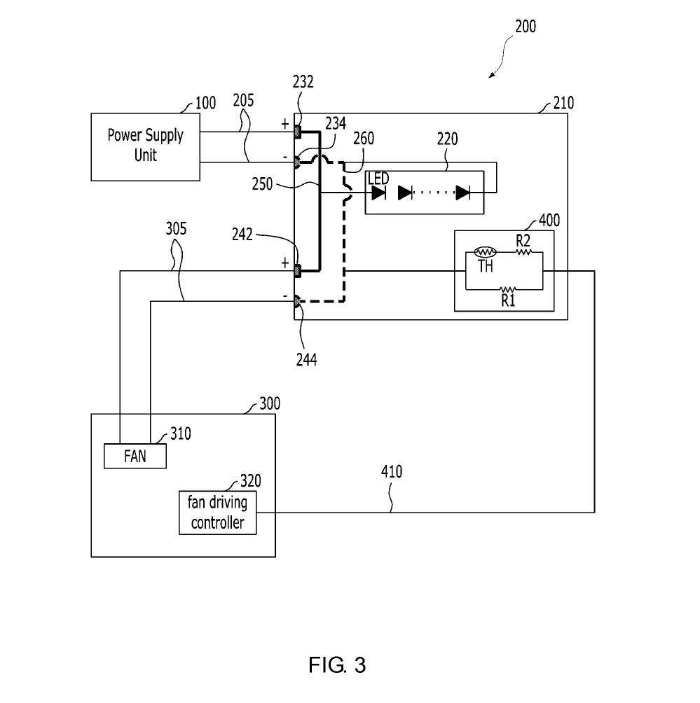

Hereinafter, this exemplary embodiment of this invention will be described in detail with reference to FIGS. 3 through 6.

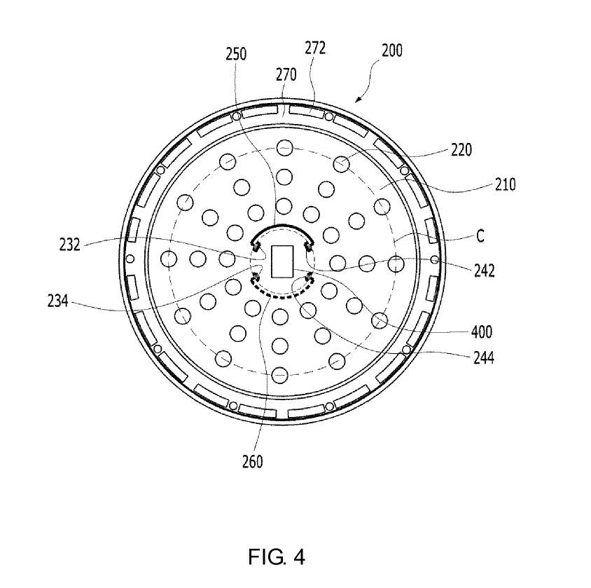

FIG. 3 is a block diagram illustrating the connection of a power supply unit, a fan module, and a light emitting module shown in FIG. 1 according to a second exemplary embodiment, and FIG. 4 is a schematic plan view illustrating a PCB including LEDs, power patterns, and power terminals shown in FIG. 3.

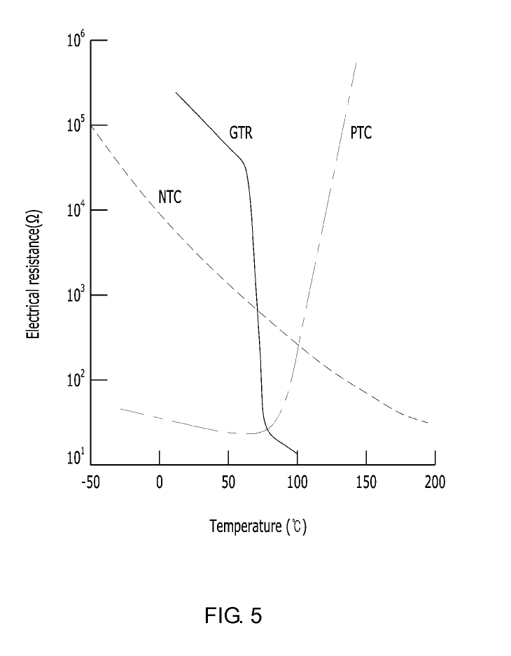

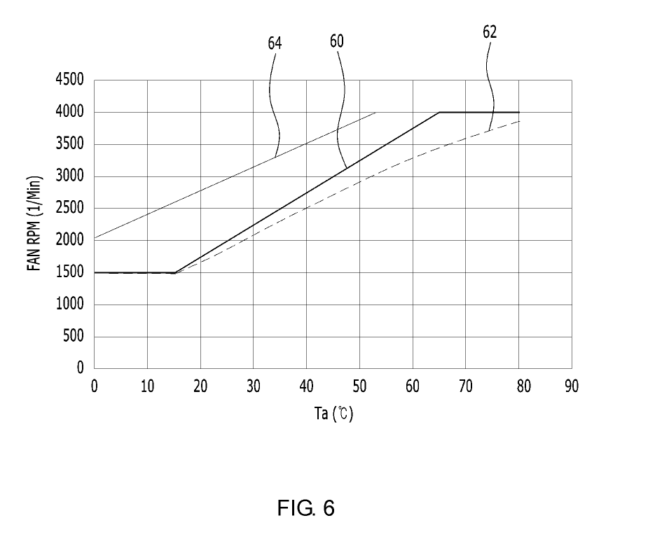

FIG. 5 is a graph to show electrical resistance-temperature characteristics of the thermistors, and FIG. 6 is a graph to explain about operation of a fan driving controller.

Referring to FIG. 3, the LED lighting apparatus according to a second exemplary embodiment includes a power supply unit 100, a light emitting module 200, and a fan module 300.

In this embodiment, components identical to those of the aforementioned embodiment are designated by like reference numerals, and their detailed descriptions are not repeated to avoid redundancy. Since the power supply unit 100 and fan module 300 are the same as the power supply unit and the fan module in FIG. 1 and FIG. 2, their detailed descriptions are not repeated.

The light emitting module 200 may include printed circuit board (PCB) 210 and a plurality of LEDs 220 disposed on the PCB 210, and a temperature sensor 400 disposed on the PCB 210.

The LEDs 220 may be connected in series as shown in FIG. 3. However, this is merely one embodiment, and the present invention is not necessarily limited thereto.

As shown in FIG. 4, the PCB 210 may be a circular shape. The LEDs 220 may be disposed apart from each other on the one side (e.g. lower side) of the PCB 210, and electrically coupled to each other regardless of the distance with circuit patterns (not shown) formed on the other side (e.g. upper side) of the PCB 210. The LEDs 220 may be arranged along a periphery of the PCB 210 on a circle (C) indicated by a dash-dot-dotted line and the plural LEDs 220 are arranged over most regions within the circle (C). In a central region of the PCB 210, the LEDs 220 are not placed in order to provide space for components (e.g. the temperature sensor 400), power terminals 232, 234, 242, 244, and power patterns 250, 260.

The PCB 210 may be a metal core PCB (MCPCB) or metal PCB (MPCB) based on a metal board having good thermal conductivity.

Referring to FIG. 4, a circular PCB 210 may be provided to a substantially disk-shaped heat sink base 270 by attaching or fastening the PCB 210 to the heat sink base 270. A plurality of exhaust ports 272 may be arranged at regularly intervals along the periphery of the heat sink base 270 surrounding the circular PCB 210. The heat sink base 270 may be formed of a metallic material such as a copper or aluminum, which has good thermal conductivity.

The fan 310, for example, may be placed below the power supply unit (e.g. SMPS) and draw cold air from outside through the air suction ports (not shown) such that the suctioned air removes heat generated from the SMPS that is transferred upwards by convection while being forcibly blown downwards by the fan. Then the cold air cools the light emitting module in cooperation with the heat sink base 270 and is then finally discharged outside through the air exhaust ports 272.

Referring to FIG. 3 and FIG. 4, The PCB 210 has a positive (+) input power terminal 232, a negative (−) input power terminal 234, a positive (+) output power terminal 242, and a negative (−) output power terminal 244. The positive (+) input power terminal 232 is electrically coupled to the positive (+) output power terminal 242 through a first power pattern 250 formed on the PCB 210, and the negative (−) input power terminal 234 is electrically coupled to the negative (−) output power terminal 244 through a second power pattern 260 formed on the PCB 210. The first and second power patterns 250, 260 are formed on the one side (e.g. upper side) of the PCB 210 same as the circuit patterns formed on the upper side of the PCB 210.

As shown in FIG. 3, a pair of first power lines 205 from the power supply unit 100 may connect with the positive (+) input terminal 232 and the negative (−) input power terminal 234, and a pair of second power lines 305 connected to the fan module 300 may connect with the positive (+) output power terminal 242 and the negative (−) output power terminal 244.

Specifically, the LEDs 220 connected in series are electrically coupled to the positive (+) input power terminal 232 and the negative (−) input power terminal 234 through circuit patterns formed on the PCB. That is, the anode electrode of the LEDs is electrically coupled to the positive (+) input power terminal 232 and the cathode electrode of the LEDs is electrically coupled to the negative (−) input power terminal 234. Therefore, the power (e.g., DC current) from the power supply unit 100 may apply to the LEDs 220 in the light emitting module 200 by the input power terminals 232, 234 and the circuit patterns corresponding thereof.

Also, the fan 310 in the fan module 300 may be electrically coupled to the power supply unit 100 through the output power terminals 242, 244, the power patterns 250, 260, and the input power terminals 232, 234 in the light emitting module 200. That is, a positive (+) terminal of the fan 310 is electrically coupled to the a positive (+) terminal of the power supply unit 100 through the positive (+) output terminal 242, the first power pattern 250, and the positive (+) input terminal 232 disposed on the PCB 210 of the light emitting module 200. Likewise, a negative (−) terminal of the fan 310 is electrically coupled to the negative (−) terminal of the power supply unit 100 through the negative (−) output terminal 244, the second power pattern 260, and the negative (−) input terminal 234 disposed on the PCB 210 of the light emitting module 200.

Therefore, the power (e.g., DC voltage) from the power supply unit 100 may be applied to the fan module 300 through the power terminals 232, 234, 242, 244 and the power patterns 250, 260.

The temperature sensor 400 may be disposed on the one side of the PCB 210. For example, if the temperature sensor 400 is formed as patterns like the circuit patterns, the temperature sensor may be disposed on the upper side of the PCB 210 with the other circuit patterns. On the other hand, if the temperature sensor 400 is formed as an IC (Integrated Circuit), the temperature sensor may be disposed on the lower side of the PCB 210 with the LEDs 220.

The temperature sensor 400 may include at least one thermistor and at least one resistor as shown in FIG. 3. For example, the temperature sensor 400 may comprise a first and second resistor R1, R2 connected in parallel, and a thermistor TH connected with the first resistor R1 in parallel, and connected with the second resistor R2 in series. The first resistor R1 is connected in parallel to the thermistor TH and may impart linearity to nonlinear characteristics of the thermistor TH.

The temperature sensor 400 may be electrically coupled between the negative (−) input terminal 234 and sensing line 410 of the fan driving controller 320 in the fan 300. That is, one side of the temperature sensor 400 is electrically coupled to the circuit pattern connected to the negative (−) input terminal 234, and the other side of the temperature sensor 400 is electrically coupled to the circuit pattern connected to the sensing line 410 into the fan driving controller 320.

The thermistor TH may be a negative temperature coefficient (NTC) thermistor whose resistance value decreases with rising temperature, or a positive temperature coefficient (PTC) thermistor whose resistance value increases with rising temperature, or a critical temperature resistor (CTR) whose resistance value increases with a specific temperature. Electrical resistance-temperature characteristics of the NTC, PTC, and CTR types are illustrated in FIG. 5. In this exemplary embodiment, the thermistor TH is of the NTC type, but this is merely one embodiment, and the present invention is not necessarily limited thereto.

Therefore, if the ambient temperature is increased, the resistance value of the thermistor TH (NTC) is decreased, so that the total resistance of the first resistor R1, second resistor R2, and the thermistor TH is decreased. In contrast, when the ambient temperature is decreased, since the resistance of the thermistor TH increases, the total resistance of the first resistor R1, second resistor R2, and the thermistor TH is increased.

Therefore, the total resistance of the temperature sensor (e.g., the combination of the first resistor R1, the second resistor R2, and the thermistor TH) may be the temperature information, and the temperature information in the form of the total resistance of the temperature sensor may be provided to the fan driving module 320 through the sensing line 410.

The sensing line 410 may comprise a plurality of lines connected between the temperature sensor 400 and the fan driving module 310. However, only one sensing line 410 is illustrated in FIG. 3 for convenience.

As described above, RPM of the fan 310 should be controlled according to the ambient air temperature. That is, when the ambient air temperature is higher than the reference temperature, the RPM of the fan should increase in order to maintain a suitable temperature of the light emitting module. In contrast, when the ambient air temperature is lower than the reference temperature, the RPM of the fan may remain constant or decrease because the temperature of the light emitting module is not so high as to require being cooled down artificially.

Thus, the fan driving controller 320 may control the rotation speed of the fan 310 according to the temperature information provided by a temperature sensor 400. For example, when the temperature information (e.g. the total resistance of the temperature sensor) is provided to the fan driving controller, the value of the total resistance may be converted to a control signal to control the rotation speed of the fan 310 by using the pull-up resistors (not shown) in the fan driving controller 320. The control signal may be a detection voltage. The detection voltage may be varied according to the change of the total resistance of the temperature sensor. That is, if the ambient temperature is increased so that the total resistance of the temperature sensor is decreased, the detection voltage also may be decreased.

However, since the temperature sensor 400 is disposed on the PCB 210 in the light emitting module 200, a temperature sensed by the temperature sensor 400 may be different than the ambient air temperature outside of the LED lighting apparatus. In general, because the heat from elements (e.g., LEDs) is generated, the temperature sensed by the temperature sensor may often be higher than the ambient air temperature outside of the LED lighting apparatus.

Accordingly, in a case of using the temperature information from the temperature sensor 400 disposed on the PCB 210, the fan driving controller 320 may control the rotation speed of the fan differently.

FIG. 6 is a graph to explain about operation of a fan driving controller, and the fan driving controller may control the RPM of the fan in accordance to the graph in FIG. 6.

Referring to FIG. 6, the first solid line 60 indicates the fan RPM responding to the ambient air temperature, and the dotted line 62 indicates the fan RPM responding to the temperature sensed by the temperature sensor disposed on the PCB. And the second solid line 64 indicates the fan RPM responding to the temperature sensed by a temperature sensor located adjacent to the fan.

As illustrated in FIG. 6, the first solid line 60 shows that the rotation speed of the fan 310 may increase when the ambient air temperature is higher than a first reference temperature (e.g. 15° C.) until the ambient air temperature reaches a second reference temperature (e.g. 65° C.). That is, the rotation speed of the fan may increase from the first reference temperature to the second reference temperature. Moreover, the rotation speed of the fan may remain constant when the ambient air temperature is lower than the first reference temperature or the ambient air temperature is higher than the second reference temperature. For example, referring to FIG. 6, when the ambient air temperature is lower than the first reference temperature, the RPM of the fan may remain constant at 1500 (l/min), and when the ambient air temperature is higher than the second reference temperature, the RPM of the fan remain constant at 4000 (l/min).

As described above, the temperature sensed by the temperature sensor 400 may be higher than the ambient air temperature of the LED lighting apparatus because the temperature sensor 400 is disposed on the PCB 210 in the light emitting module 200. Therefore, the fan RPM may decrease as compared with the same temperature sensed by the ambient air.

For example, referring to FIG. 6, if the ambient air temperature is 40° C., the RPM of the fan may change to about 2750 (l/min) according to the first solid line 60, whereas if the temperature sensed by temperature sensor disposed on the PCB is 40° C., the RPM of the fan may may change to about 2500 (l/min) according to the dotted line 62.

In contrast, if the temperature sensed by a temperature sensor (e.g. a temperature sensor located adjacent to the fan) is lower than the ambient air temperature, the fan RPM may increase as compared with the same temperature sensed by the ambient air.

For example, referring to the FIG. 6, if the ambient air temperature is 40° C., the RPM of the fan may change to about 2750 (l/min) according to the first solid line 60, whereas if the temperature sensed by temperature sensor located adjacent to the fan is 40° C., the RPM of the fan may change to about 3500 (l/min).

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A light emitting diode (LED) lighting apparatus, comprising:
a power supply unit configured to convert AC current and/or voltage into DC current and/or voltage and output the converted DC current and/or voltage;
a light emitting module comprising a printed circuit board (PCB) and a plurality of LEDs disposed on a first side of the PCB, wherein the light emitting module is configured to receive the DC current from the power supply unit ;
a fan module configured to receive the DC voltage from the power supply unit; and
a temperature sensor configured to generate temperature information and transmit the temperature information to the fan module,
wherein the temperature sensor is disposed on the PCB.

2. The LED lighting apparatus of claim 1, wherein the power supply unit includes a switching mode power supply (SMPS) configured to convert AC current and/or voltage into DC current and/or voltage, and a light emitting driving controller configured to apply a substantially constant DC current to the light emitting module.

3. The LED lighting apparatus of claim 2, wherein the SMPS includes an AC/DC converter configured to convert an AC voltage from an external source to a DC voltage, and a DC/DC converter configured to convert the converted DC voltage to a first DC voltage.

4. The LED lighting apparatus of claim 3, wherein the light emitting driving controller is electrically coupled to the DC/DC converter and is configured to maintain the constant DC current applied to the light emitting module by controlling the first DC voltage.

5. The LED lighting apparatus of claim 1, wherein the PCB is a metal core PCB (MCPCB) or metal PCB (MPCB) based on a metal board.

6. The LED lighting apparatus of claim 1, wherein the PCB comprises:
a positive (+) input power terminal and a negative (−) input power terminal that are electrically coupled to the power supply unit, and
a positive (+) output power terminal and a negative (−) output power terminal that are electrically coupled to the fan module, and
wherein the positive (+) input power terminal is electrically coupled to the positive (+) output power terminal through a first power pattern formed on a second side of the PCB, and
the negative (−) input power terminal is electrically coupled to the negative (−) output power terminal through a second power pattern formed on the second side of the PCB.

7. The LED lighting apparatus of claim 6, wherein the plurality of LEDs are connected in series, and electrically coupled to the positive (+) input power terminal and the negative (−) input power terminal.

8. The LED lighting apparatus of claim 1, wherein the plurality of LEDs are disposed apart from each other on the first side of the PCB and electrically coupled to each other with circuit patterns formed on a second side of the PCB.

9. The LED lighting apparatus of claim 1, wherein the fan module comprises:
a fan providing a cooling air by rotating rotor blades; and
a fan driving controller configured to control a rotation speed of the fan's rotor blades according to the temperature information provided by the temperature sensor.

10. The LED lighting apparatus of claim 1, wherein the temperature sensor comprises a thermistor and a resistor.

11. The LED lighting apparatus of claim 10, wherein the temperature sensor comprises a first and second resistor connected in parallel, and a thermistor connected with the first resistor in parallel and connected with the second resistor in series.

12. The LED lighting apparatus of claim 10, wherein the thermistor is a negative temperature coefficient (NTC) thermistor whose resistance value decreases with rising temperature.

13. The LED lighting apparatus of claim 10, wherein total resistance of the temperature sensor is related to the temperature information provided to a fan driving module in the fan module through a sensing line.

14. The LED lighting apparatus of claim 9, wherein the rotation speed of the fan is increased when the ambient air temperature is higher than a first reference temperature until the ambient air temperature reaches a second reference temperature.

15. The LED lighting apparatus of claim 1, wherein the temperature sensed by the temperature sensor is higher than ambient air temperature and corresponds to a rotation speed of the fan module that is lower than rotation speed of the fan module having the same temperature sensed from the ambient air.

16. The LED lighting apparatus of claim 1, wherein the temperature sensor is disposed on the first side of the PCB

17. The LED lighting apparatus of claim 1, wherein the temperature sensor is disposed on a side opposite the first side of the PCB.
